(19) United States
(12) Patent Application Publication
(10) Pub. No.: US 2021/0146472 A1
(43) Pub. Date: May 20, 2021

(54) JOINING METHOD

(71) Applicant: NIPPON LIGHT METAL COMPANY, LTD., Tokyo (JP)

(72) Inventors: Hisashi HORI, Shizuoka (JP); Kosuke YAMANAKA, Shizuoka (JP)

(73) Assignee: NIPPON LIGHT METAL COMPANY, LTD., Tokyo (JP)

(21) Appl. No.: 16/622,559

(22) PCT Filed: Jan. 25, 2018
(86) PCT No.: PCT/JP2018/002207

§ 371 Date: Dec. 13, 2019

(30) Foreign Application Priority Data
Nov. 15, 2017 (JP) 2017-220202

(51) Int. Cl. B23K 20/12

(52) U.S. Cl. CPC B23K 20/1255

(57) ABSTRACT

A first metal member (1) and a second metal member (2) are joined together using a rotary tool (F1D) comprising a base side pin (F3) and a tip side pin (F4), comprising an overlapping and abutting process of forming an overlapped portion (J1a), a top side abutted portion (J1b) and a back side abutted portion (J1c), and a friction stirring process of inserting the tip side pin (F4) that is rotating into the top side abutted portion (J1b) to join the top side abutted portion (J1b) and the overlapped portion (J1a) with a flat face (F5) vertical to a rotation axis of the rotary tool (F1D) being in contact with both the first metal member (1) and the second metal member (2) and with a tip face (f7) of a protruding portion (F6) protruding from the flat face (F5) being inserted deep over the overlapped portion (J1a).

### FIELD OF THE INVENTION

The present invention relates to a joining method.

### BACKGROUND ART

There has been a rotary tool used as a rotating tool for friction-stir welding that comprises a shoulder portion and a stirring pin that extends vertically from the shoulder portion. A friction stir welding method to join double-skin panels with this rotary tool has been known (See Patent Document 1). This rotary tool is intended to be used with its lower face of the shoulder portion being on a metal member while a friction stirring process is under way. Since the shoulder portion is pushed onto the metal member, the plastically flowing material is kept pressed and a burr can be inhibited from being generated. However, if the height of the joined portion changes, such defects as larger concave grooves and a lot of burrs are easily generated.

On one hand, a friction stir welding method to join a couple of metal members with a rotary tool having a stirring pin is known (See Patent Document 2). This method comprises a joining process of putting the stirring pin that is rotating into an abutted portion of a couple of metal members to friction-stir-weld them using only the stirring pin being in contact with the couple of the metal members. The stirring pin has an outer circumferential face on which a spiral groove is engraved, and friction stir welding is performed with only the stirring pin being in contact with the metal members to be joined and a base portion of the stirring pin being exposed. As a result, defects are inhibited from being generated even when the height of the joined portion changes and a load applied to the friction stir welding device can be reduced. However, since the plastically flowing material is not pressed by the shoulder portion, there are problems with a larger surface roughness of the joined portion as well as a larger concave groove formed on the joined metal members. In addition, there is another problem with a bank portion (the surface of metal member's portion that is elevated compared with that before joined) formed on each side of the concave groove.

On the other hand, the Patent Document 3 describes a rotary tool comprising a shoulder portion and a stirring pin extending vertically from the shoulder portion. An outer circumferential face of the shoulder portion and an outer circumferential face of the stirring pin are tapered, respectively. On the tapered face of the shoulder portion is engraved a groove that is seen as a volute in planar view. The groove has a cross section in a half circle shape. With this tapered face, metal members can be stably joined together when a thickness of the metal member or the height of the joined portion changes. In addition, since the plastically flowing material comes into the groove, a flow of the plastically flowing material is controlled and the appropriate plasticized region is formed.

### PRIOR ART DOCUMENT

### Patent Document

Patent Document 1 JP2008-279513A

Patent Document 2 JP2013-39613A Patent Document 3 JP4210148B2

### SUMMARY OF THE INVENTION

### Objective to be Achieved

However, looking to the prior art technology of Patent Document 3, the plastically flowing material comes into the groove on the tapered face and the groove does not work as intended, which is a problem. In addition, once the plastically flowing material comes into the groove, the friction stir welding is performed with the plastically flowing material stuck in the groove rubbing against the metal member material to be joined, which results in a problem with a joined portion with deteriorated joining quality. Furthermore, the joined members have a rough surface and many burrs and have a problem with a large groove on the surface being formed.

In order to solve the problems above described, the present invention is intended to provide a joining method through which the joined metal members can have a smaller groove on its surface and a smaller surface roughness.

### Means to Achieve the Objective

In order to solve problems above described, the present invention has an aspect of joining a first metal member and a second metal member together using a rotary tool for friction stir welding comprising a base side pin and a tip side pin, comprising processes of a preparation process of forming a first step bottom face and a first step side face on a top face of an end portion of the first metal member and forming a second step bottom face and a second step side face on a back face of an end portion of the second metal member, an overlapping and abutting process of forming an overlapped portion of the first step bottom face and the second step bottom face which are overlapped with each other and forming a top side applied portion of the first step side face and an end face of the second metal member which abut each other and a back side abutted portion of the second step side face and an end face of the first metal member which abut each other, and a friction stirring process of inserting the tip side pin that is rotating into the top side abutted portion and moving the rotary tool along the top side abutted portion with each of the base side pin and the tip side pin being in contact with both the first metal member and the second metal member to join each of the top side abutted portion and the overlapped portion, wherein the base side pin has a first taper angle while the tip side pin has a second taper angle that is smaller than the first taper angle, a circumferential face of the base side pin has a step portion in a staircase shape formed thereon and the tip side pin has a flat face that is vertical to a rotation axis of the rotary tool and a protruding portion protruding from the flat face, and wherein each of the top side abutted portion and the overlapped portion is being joined with the flat face being in contact with both the first metal member and the second metal member and with a tip face of the protruding portion being inserted deep over the overlapped portion in the friction stirring process.

Additionally, the present invention has an aspect of joining a first metal member and a second metal member together using a rotary tool for friction stir welding comprising a base side pin and a tip side pin, comprising processes of a preparation process of forming a first step bottom face and a first step side face on a top face of an end portion of the first metal member and forming a second step bottom face and a second step side face on a back face of an end portion of the second metal member, an overlapping and abutting process of forming an overlapped and abutted portion of the first step bottom face and the second step bottom face which are overlapped with each other and forming a top side abutted portion of the first step side face and an end face of the second metal member which abut each other and a back side abutted portion of the second step side face and an end face of the first metal member which abut each other, and a friction stirring process of inserting the tip side pin that is rotating into the back side abutted portion and moving the rotary tool along the back side abutted portion with each of the base side pin and the tip side pin being in contact with both the first metal member and the second metal member to join each of the back side abutted portion and the overlapped portion, wherein the base side pin has a first taper angle while the tip side pin has a second taper angle that is smaller than the first taper angle, a circumferential face of the base side pin has a step portion in a staircase shape formed thereon and the tip side pin has a flat face that is vertical to a rotation axis of the rotary tool and a protruding portion protruding from the flat face, and wherein each of the back side abutted portion and the overlapped portion is being joined with the flat face being in contact with both the first metal member and the second metal member and with a tip face of the protruding portion being inserted deep over the overlapped portion in the friction stirring process.

Additionally, the present invention has an aspect of joining a first metal member and a second metal member together using a rotary tool for friction stir welding comprising a base side pin and a tip side pin, the joining method comprising processes of a preparation process of forming a first step bottom face and a first step side face on a top face of an end portion of the first metal member and forming a second step bottom face and a second step side face on a back face of an end portion of the second metal member, an overlapping and abutting process of forming an overlapped portion of the first step bottom face and the second step bottom face which are overlapped with each other and forming a top side abutted portion of the first step side face and an end face of the second metal member which abut each other and a back side abutted portion of the second step side face and an end face of the first metal member which abut each other, and a friction stirring process of inserting the tip side pin that is rotating into the top side abutted portion and moving the rotary tool along the top side abutted portion with each of the base side pin and the tip side pin being in contact with both the first metal member and the second metal member to join the top side abutted portion, wherein the base side pin has a first taper angle while the tip side pin has a second taper angle that is smaller than the first taper angle, a circumferential face of the base side pin has a step portion in a staircase shape formed thereon and the tip side pin has a flat face that is vertical to a rotation axis of the rotary tool and a protruding portion protruding from the flat face, and wherein the top side abutted portion is being joined with each of the flat face and the protruding portion being in contact with both the first metal member and the second metal member in the friction stirring process.

Additionally, the present invention has an aspect of joining a first metal member and a second metal member together using a rotary tool for friction stir welding comprising a base side pin and a tip side pin, comprising processes of a preparation process of forming a first step bottom face and a first step side face on a top face of an end portion of the first metal member and forming a second step bottom face and a second step side face on a back face of an end portion of the second metal member, an overlapping and abutting process of forming an overlapped portion of the first step bottom face and the second step bottom face which are overlapped with each other and forming a top side abutted portion of the first step side face and an end face of the second metal member which abut each other and a back side abutted portion of the second step side face and an end face of the first metal member which abut each other, and a friction stirring process of inserting the tip side pin that is rotating into the back side abutted portion and moving the rotary tool along the back side abutted portion with each of the base side pin and the tip side pin being in contact with both the first metal member and the second metal member to join the back side abutted portion, wherein the base side pin has a first taper angle while the tip side pin has a second taper angle that is smaller than the first taper angle, a circumferential face of the base side pin has a step portion in a staircase shape formed thereon and the tip side pin has a flat face that is vertical to a rotation axis of the rotary tool and a protruding portion protruding from the flat face, and wherein the back side abutted portion is being joined with each of the flat face and a tip face of the protruding portion being in contact with both the first metal member and the second metal member in the friction stirring process.

According to the joining method above described, since metal members can be held down by a circumferential face of the base side pin having a relatively large taper angle, a concave groove to be made on the resultant joined surface can be smaller and no bank portion or a smaller bank portion can be made on each side of the concave groove. Since the step portion in a staircase shape is shallow and has a wide exit, the plastically flowing material hardly adheres to the circumferential face of the base side pin though the metal members are held down by the base side pin. As a result, the surface roughness on the joined surface can be made smaller and the quality of the joined portion is reliably kept good. In addition, the rotary tool having a tip side pin can be easily inserted to a sufficiently deep position.

Moreover, according to the joining method above described, since the tip side pin of the rotary tool has a flat face, the plastically flowing material winding up around the protruding portion is held down by the flat face and oxide films in the overlapped portion can be reliably broken.

Additionally, the present invention has an aspect of joining a first metal member and a second metal member together using a rotary tool for friction stir welding comprising a base side pin and a tip side pin, comprising processes of a preparation process of forming a first step bottom face and a first step side face on a top face of an end portion of the first metal member and forming a second step bottom face and a second step side face on a back face of an end portion of the second metal member, an overlapping and abutting process of forming an overlapped portion of the first step bottom face and the second step bottom face which are overlapped with each other and forming a top side abutted portion of the first step side face and an end face of the second metal member which abut each other and a back side abutted portion of the second step side face and an end face of the first metal member which abut each other, and a friction stirring process of inserting the tip side pin that is rotating into the top side abutted portion and moving the rotary tool along the top side abutted portion with each of the base side pin and the tip side pin being in contact with both the first metal member and the second metal member to joine the top side abutted portion, wherein the base side pin has a first taper angle while the tip side pin has a second taper angle that is smaller than the first taper angle and a circumferential face of the base side pin has a step portion in a staircase shape formed thereon.

Additionally, the present invention has an aspect of joining a first metal member and a second metal member together using a rotary tool for friction stir welding comprising a base side pin and a tip side pin, comprising processes of a preparation process of forming a first step bottom face and a first step side face on a top face of an end portion of the first metal member and forming a second step bottom face and a second step side face on a back face of an end portion of the second metal member, an overlapping and abutting process of forming an overlapped portion of the first step bottom face and the second step bottom face which are overlapped with each other and forming a top side abutted portion of the first step side face and an end face of the second metal member which abut each other and a back side abutted portion of the second step side face and an end face of the first metal member which abut each other, and a friction stirring process of inserting the tip side pin that is rotating into the back side abutted portion and moving the rotary tool along the back side abutted portion with each of the base side pin and the tip side pin being in contact with both the first metal member and the second metal member to join the back side abutted portion, wherein the base side pin has a first taper angle while the tip side pin has a second taper angle that is smaller than the first taper angle and a circumferential face of the base side pin has a step portion in a staircase shape formed thereon.

Additionally, the present invention has an aspect of a flat face formed on a tip of the tip side pin being inserted deep over the overlapped portion in the friction stirring process.

According to the joining method as described above, since metal members are held down by the circumferential face of the base side pin having a relatively large taper angle, a concave groove to be formed on the joined surface can be made smaller and no bank portion or a smaller bank portion can be made on the concave groove. Since the step portion in a staircase shape is shallow and has a wide exit, the plastically flowing material hardly adheres to the circumferential face of the base side pin though the metal members are held down by the base side pin. As a result, the surface roughness on the joined surface can be made smaller and the quality of the joined portion is reliably kept good. In addition, the rotary tool having a tip side pin can be easily inserted to a sufficiently deep position.

Additionally, the present invention has an aspect of joining a first metal member and a second metal member together using a rotary tool for friction stir welding comprising a base side pin and a tip side pin, comprising processes of a stacking process of forming an overlapped portion of a top face of the first metal member and a back face of the second metal member which are overlapped with each other, and a friction stirring process of inserting the tip side pin that is rotating into the overlapped portion from a surface of the second metal member so that only the tip side pin is in contact with the first metal member and moving the rotary tool along the overlapped portion with the base side pin and the tip side pin both being in contact with the second metal member to join the overlapped portion, wherein the base side pin has a first taper angle while the tip side pin has a second taper angle that is smaller than the first taper angle, a circumferential face of the base side pin has a step portion in a staircase shape formed thereon and the tip side pin has a flat face that is vertical to a rotation axis of the rotary tool and a protruding portion protruding from the flat face, and wherein the overlapped portion is being joined with the flat face being in contact with the second metal member and a tip face of the protruding portion being in contact with the first metal member in the friction stirring process.

According to the joining method as described above, since metal members are held down by the circumferential face of the base side pin having a relatively large taper angle, a concave groove to be formed on the joined surface can be made smaller and no bank portion or a smaller bank portion can be made on the concave groove. Since the step portion in a staircase shape is shallow and has a wide exit, the plastically flowing material hardly adheres to the circumferential face of the base side pin though the metal members are held down by the base side pin. As a result, the surface roughness on the joined surface can be made smaller and the quality of the joined portion is reliably kept good. In addition, the rotary tool having a tip side pin can be easily inserted to a sufficiently deep position.

Moreover, according to the joining method above described, since the tip side pin of the rotary tool has a flat face, the plastically flowing material winding up around the protruding portion is held down by the flat face and oxide films in the overlapped portion can be reliably broken.

Additionally, the present invention has an aspect of joining a first metal member and a second metal member together using a rotary tool for friction stir welding comprising a base side pin and a tip side pin, comprising processes of a stacking process of forming an overlapped portion of a top face of the first metal member and a back face of the second metal member which are overlapped with each other, and a friction stirring process of inserting the tip side pin that is rotating into the overlapped portion from a surface of the second metal member and moving the rotary tool along the overlapped portion with the base side pin and the tip side pin both being in contact with the second metal member to join the overlapped portion, wherein the base side pin has a first taper angle while the tip side pin has a second taper angle that is smaller than the first taper angle and a circumferential face of the base side pin has a step portion in a staircase shape formed thereon, and wherein the overlapped portion is being joined with the tip side pin being in contact either with only the second metal member or with both the second metal member and the first metal member.

According to the joining method as described above, since metal members are held down by the circumferential face of the base side pin having a relatively large taper angle, a concave groove to be formed on the joined surface can be made smaller and no bank portion or a smaller bank portion can be made on the concave groove. Since the step portion in a staircase shape is shallow and has a wide exit, the plastically flowing material hardly adheres to the circumferential face of the base side pin though the metal members are held down by the base side pin. As a result, the surface roughness on the joined surface can be made smaller and the quality of the joined portion is reliably kept good. In addition, the rotary tool having a tip side pin can be easily inserted to a sufficiently deep position.

### Effect of the Invention

According to the present invention, a concave groove on the joined metal members can be made smaller and the surface roughness on the joined metal members can be made smaller as well.

### BRIEF DESCRIPTION OF THE DRAWINGS

FIG. 1 is a cross-sectional view showing a preparation process of a joining method of a first embodiment of the present invention.

FIG. 2 is a cross-sectional view showing an overlapping and abutting process of the joining method of the first embodiment.

FIG. 3 is a side elevational view of a rotary tool.

FIG. 4 is an enlarged cross-sectional view of the rotary tool.

FIG. 5 is a cross-sectional view showing a friction stirring process of an upper top side portion of a joining method of the first embodiment.

FIG. 6 is a cross-sectional view showing a friction stirring process of an upper back side portion of a joining method of the first embodiment.

FIG. 7 is a conceptional view of a rotary tool of the prior art.

FIG. 8 is a conceptional view of a rotary tool of the prior art.

FIG. 9 is a cross-sectional view of an upper top side portion of a joining method of a second embodiment.

FIG. 10 is a cross-sectional view of an upper back side portion of a joining method of the second embodiment.

FIG. 11 is a cross-sectional view of an upper top side portion of a joining method of a third embodiment.

FIG. 12 is a cross-sectional view of an upper back side portion of a joining method of the third embodiment.

FIG. 13 is a cross-sectional view of an upper top side portion of a joining method of a fourth embodiment.

FIG. 14 is a cross-sectional view of an upper back side portion of a joining method of the fourth embodiment.

FIG. 15 is a cross-sectional view showing a friction stirring process of a joining method of a fifth embodiment.

FIG. 16 is a cross-sectional view showing a friction stirring process of a joining method of a sixth embodiment.

FIG. 17 is a cross-sectional view of a rotary tool of a first modified example.

FIG. 18 is a cross-sectional view of a rotary tool of a second modified example.

FIG. 19 is a cross-sectional view of a rotary tool of a third modified example.

### DETAILED DESCRIPTION OF THE INVENTION

### First Embodiment

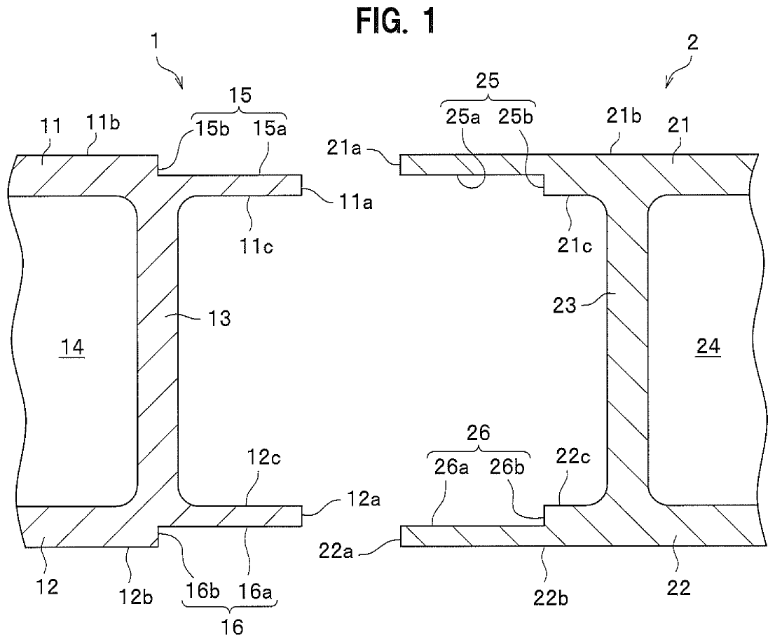

Joining methods of embodiments of the present invention are explained with reference to the attached figures. According to a joining method of the first embodiment of the present invention as sown in FIG. 1, a first metal member 1 that is a double skin panel and a second metal member 2 that is the other double skin panel are joined together through friction stir welding. Hereinafter, “top face” is referred to as an opposite face to “back face”.

Each of the first metal member 1 and the second metal member 2 is made of a material that can be friction-stirred. For example, each of the first metal member 1 and the second metal member 2 may be made of any metal material appropriately selected from a group of aluminium, aluminium alloys, cupper, cupper alloys, titanium, titanium alloys, magnesium, magnesium alloys and other metals or metal alloys. A preparation process, an overlapping and abutting process and a friction stirring process are carried out in the joining process of this embodiment.

The preparation process is intended to prepare the first metal member 1 and the second metal member 2. The first metal member 1 may consist mainly of an upper base plate 11, a lower base plate 12 and a support plate 13. The first metal member 1 may be, for example, an extruded frame member. An upper step portion 15 is formed on a top face 11b that is an end portion of the upper base plate 11. The first upper step portion 15 comprises a first upper step bottom face (first step bottom face) 15a and a first upper step side face (first step side face) 15b. The first upper step bottom face 15a and the first upper step side face 15b are vertical to each other. An inner space 14 is formed between the upper base plate 11 and the lower base plate 12.

A first lower step portion 16 is formed on an end portion of a top face 12b of the lower base plate 12. The first lower step portion 16 comprises a first lower step bottom face (first step bottom face) 16a and a first lower step side face (first step side face) 16b. The first lower step bottom face 16a and the first lower step side face 16b are vertical to each other. The support plate 13 is a plate-like shaped member that is vertically joined to each of a back face 11c of the upper base plate 11 and a back face 12c of the lower base plate 12. A corner portion between the upper base plate 11 and the support plate 13 is in an arc shape. A corner portion between the lower base plate 12 and the support plate 13 is in an arc shape as well.

The second metal member 2 consists mainly of an upper base plate 21, a lower base plate 22 and a support plate 23. The second metal member 2 may be an extruded frame member. A second upper step portion 25 is formed on a back face 21c that is an end portion of the upper base plate 21. The second upper step portion 25 comprises a second upper step bottom face (second step bottom face) 25a and a second upper step side face (second step side face) 25b. The second upper step bottom face 25a and the second upper step side face 25b are vertical to each other. An inner space 24 is formed between the upper base plate 21 and the lower base plate 22.

A second lower step portion 26 is formed on an end portion of a back face 22c of the lower base plate 22. The second lower step portion 26 comprises a second lower step bottom face (second step bottom face) 26a and a second lower step side face (second step side face) 26b. The second lower step bottom face 26a and the second lower step side face 26b are vertical to each other. The support plate 23 is a plate-like shaped member that is joined to a back face 21c of the upper base plate 21 and a back face 22c of the lower base plate 22 so as to be vertical to them. Corner portions between the upper base plate 21 and the support plate 23 are in an arc shape. Corner portions between the lower base plate 22 and the support plate 23 are in an arc shape as well.

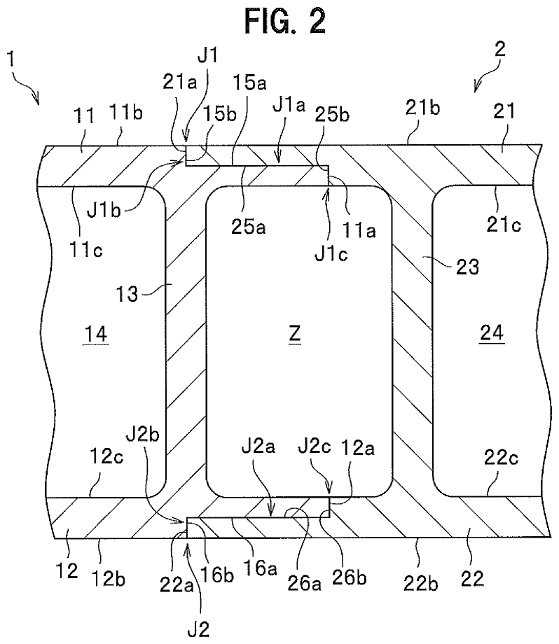

The overlapping and abutting process is intended to have an end portion of the first metal member 1 and an end portion of the second metal member 2 abut each other to form an abutted portion J1 and an abutted portion J2, as shown in FIG. 2. The abutted portion J1 includes an upper overlapped portion (overlapped portion) J1a, an upper top side abutted portion Jlb and an upper back side abutted portion J1c. The upper overlapped portion J1a is formed of the first step bottom face 15a and the second upper step bottom face 25a that are overlapped with each other. An inner space Z is formed between the support plate 13 and the support plate 23.

The upper top side abutted portion Jlb is formed of the first upper step side face 15b and an end face 21a of the upper base plate 21 that abut each other. The upper back side abutted portion J1c is formed of an end face 11a of the upper base plate 11 and the second upper step side face 25b that abut each other.

The abutted portion J2 includes a lower overlapped portion (overlapped portion) J2a, a lower top side abutted portion J2b and a lower back side abutted portion J2c. The lower overlapped portion J2a is formed of the first lower step bottom face 16a and the second lower step bottom face 26a that are overlapped with each other. The lower top side abutted portion J2b is formed of the first lower step side face 16b and an end face 22a of the lower base plate 22 that abut each other. The second back side abutted portion J2c is formed of an end face 12a of the lower base plate 12 and the second lower step side face 26b that abut each other. Since the first metal ember 1 and the second metal member 2 abut each other so that each of the abutted portions J1, J2 is in a crank shape in a cross-sectional view as explained, the abutted portions J1, J2 are prevented from being displaced during the friction stirring process.

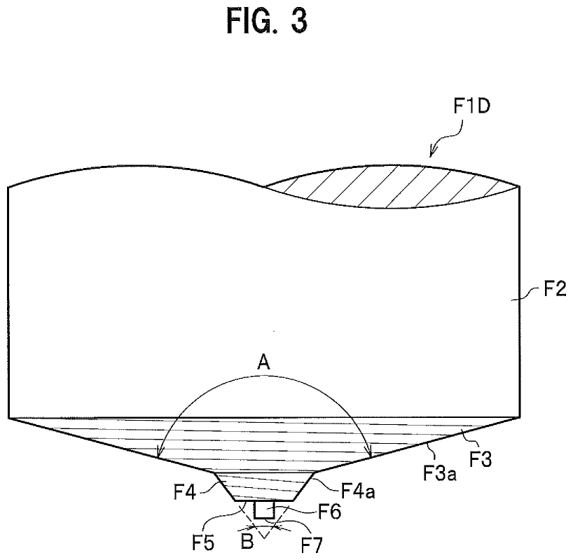

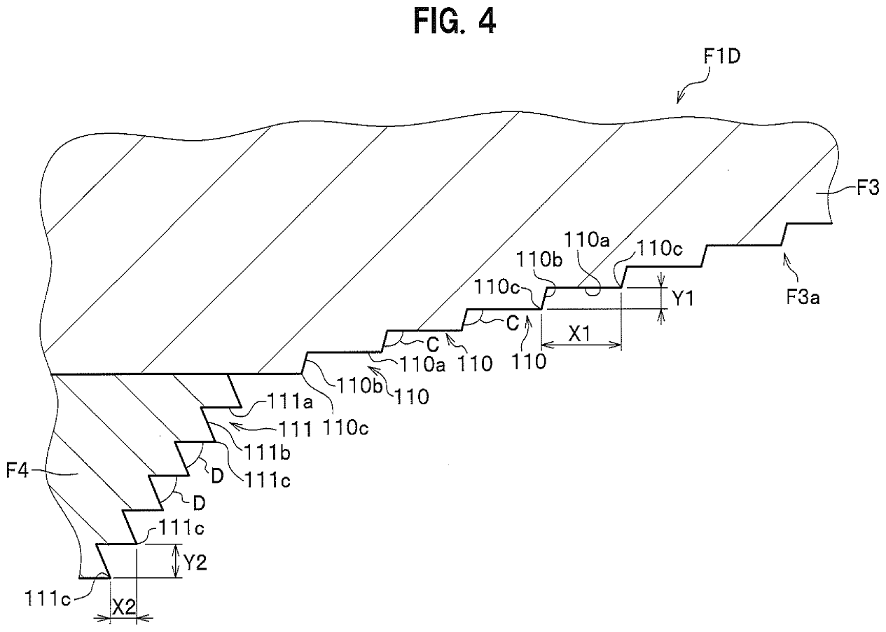

The friction stirring process is a process to perform friction stir welding with a rotary tool F1D on the abutted portions J1, J2, as shown in FIG. 3 and FIG. 4. As shown in FIG. 3, the rotary tool F1D is a tool used for friction stir welding. The rotary tool F1D is made, for example, of a tool steel. The rotary tool F1D consists mainly of a base axis portion F2, a base side pin F3 and a tip side pin F4. The tip side pin F4 has a flat face F5, on which a protruding portion F6 protruding downward is formed. The base axis portion F2 is in a columnar shape and is a member to be connected with a spindle of a friction stirring apparatus. The flat face F5 of the tip side pin F4 is vertical to a rotation axis.

The base side pin F3 extends continuously from the base axis portion F2 and is tapered toward its tip. The base side pin F3 has a shape of a truncated cone. A taper angle A of the base side pin F3 may be set appropriately and is, for example, between 135° and 160°. If the taper angle A is smaller than 135° or larger than 160°, the joined portion has a large surface roughness after friction stir welding is finished. The taper angle A is larger than a taper angle B of the tip side pin F4, as is to be explained below. As shown in FIG. 4, a step portion 110 in a staircase shape is formed over an outer circumferential face of the base side pin F3 and from a bottom to a top of the base side pin F3. The step portion 110 is formed to extend spirally from the bottom clockwise or counterclockwise. That is to say, the step portion 110 is in a spiral shape in the plain view while the step portion 110 is in a staircase shape in the cross-sectional view. In this embodiment, since the rotary tool is rotated clockwise, the step portion 110 is formed in a counterclockwise direction from the bottom to the top of the base side pin F3.

If the rotary tool is rotated counterclockwise, the step portion 110 is formed preferably in a clockwise direction from the bottom to the top. In this way, the plastically flowing material is directed to the top of the base side pin F3 and less of the plastically flowing material can come out of the joined metal material. The step portion 110 consists of a step bottom face 110a and a step side face 110 b. A length (horizontal direction pitch) X1 between a couple of adjacent apexes 110c, 110c of the step portion 110 may be determined appropriately based on a step angle C and a height Y1 of the step side face 110b which are to be described below.

The height Y1 of the step side face 110b may be appropriately determined and is, for example, set to 0.1-0.4 mm. If the height Y1 is smaller than 0.1 mm, the joined surface has a larger surface roughness. On the other hand, if the height Y1 is larger than 0.4 mm, the joined surface is likely to have a larger surface roughness and an effective number of steps (number of steps of the step portion 110 that are in contact with plastically flowing material) decreases.

The step angle C between the step bottom face 110a and the step side face 110b may be set appropriately and is, for example, set to 85°-120°. The step bottom face 110a is in parallel with the horizontal face in this embodiment. The step bottom face 110a may slope in the direction of the circumference from the rotation axis of the tool to the circumference at an angle within −5°-15° relative to the horizontal face (a negative angle corresponds to sloping downward from the horizontal face and a positive angle corresponds sloping upward from the horizontal face). The length X1, the height Y1 of the step side face Y1, the step angle C and the angle of the step bottom face 110a relative to the horizontal face are set in such a way that when friction stir welding is under way, the plastically flowing material moves out of the step portion 110 without being stuck in and adhering to the step portion 110 and the step bottom face 110a holds down the plastically flowing material to reduce the surface roughness after the joining.

The tip side pin F4 is formed to extend continuously from the base side pin F3. The tip side pin F4 is in the shape of a truncated cone shape. The flat face F5 is formed on the tip of the tip side pin F4. The flat face F5 is vertical to the rotation axis of the rotary tool F1D. The taper angle B of the tip side pin F4 is smaller than the taper angle A of the base side pin F3. A spiral groove 111 is engraved on the outer circumferential face of the tip side pin F4. The spiral groove 111 may be clockwise or counterclockwise. The spiral groove 111 is engraved counterclockwise from the bottom to the tip of the tip side pin F4 in the present embodiment in order to have the rotary tool F1D rotate clockwise.

If the rotary tool F1D is made to rotate counterclockwise, the spiral groove 111 is preferably engraved clockwise from the bottom to the tip. In this way, the spiral groove 111 directs the plastically flowing material to the tip, which enables reducing the plastically flowing metal coming out of the metal members to be joined. The spiral groove 111 consists of a spiral bottom face 111a and a spiral side face 111b. A length X2 is defined as a distance (horizontal direction distance) between a couple of adjacent apexes 111c, 111c of the spiral groove 111. A height Y2 is defined as a height of a spiral side face 111b. A spiral groove angle D between the spiral bottom face 111a and the spiral side face 111b is, for example, formed to be 45°˜90°. The spiral groove 111 functions to increase friction heat when coming in contact with the metal members to be joined and to direct the plastically flowing material to the tip.

As shown in FIG. 3, the protruding portion F6 is formed in the centre of the flat face F5 and coaxially with the base side portion F2 and protrudes from the flat face F5. The protruding portion F6 may be in any shape and is in a columnar shape in the present embodiment. A spiral groove may be engraved on the side face of the protruding portion F6.

An upper top side friction stirring process, an upper back side friction stirring process, a lower top side friction stirring process and a lower back side friction stirring process are performed in the friction stirring process of the present embodiment.

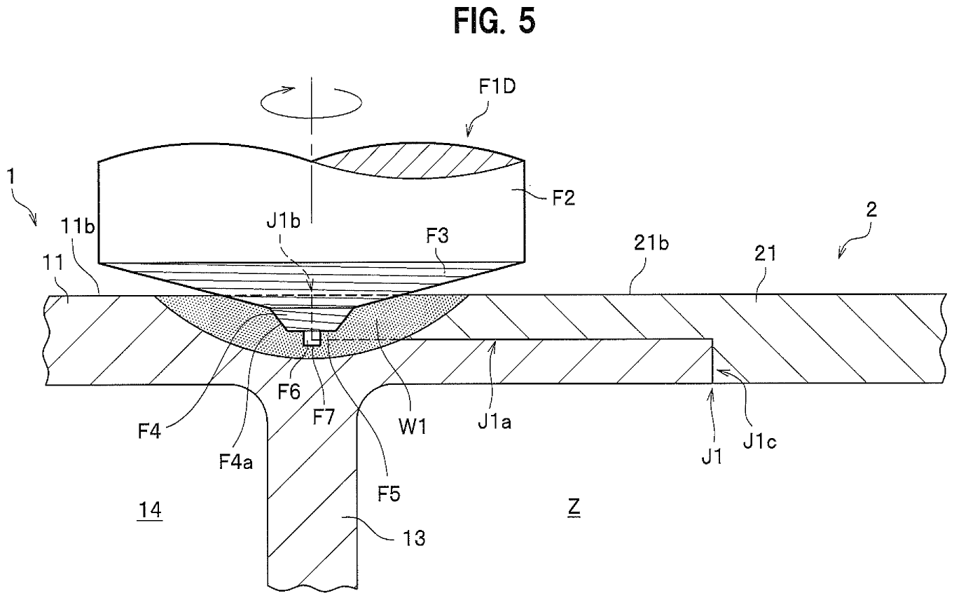

In the upper top side friction stirring process, the rotary tool F1D rotating clockwise is inserted into the upper top side abutted portion Jlb as shown in FIG. 5 and moves along the upper top side abutted portion J1b. In FIG. 5, the rotary tool F1D rotating clockwise is made to move from the frontside toward the backside. An insertion depth by which the rotary tool F1D is inserted is set to such a depth that at least a portion of the base side pin F3 is in contact with both the top face 11b of the upper base plate 11 of the first metal member 1 and the top face 21b of the upper base plate 21 of the second metal member 2. In the present embodiment, the insertion depth is set to such a depth that a portion of the circumferential face of the base side pin F3 that is close to the tip side pin F4 is in contact with the top face 11b of the upper base plate 11 and the top face 21b of the upper base plate 21. Accordingly, friction stir welding is performed with the circumferential face of the base side pin F3 of the rotary tool F1D holding down the top face 11b of the upper base plate 11 and the top face 21b of the upper base plate 21.

In addition, the insertion depth of the rotary tool F1D in this embodiment should be set to so large a depth that a tip face F7 of the protruding portion F6 is inserted deep over the upper overlapped portion J1a with the flat face F5 of the tip side pin F4 being in contact with both the first metal member 1 and the second metal member 2. Therefore, the tip face F7 of the protruding portion F6 is inserted so deep that the tip face F7 is in contact only with the first metal member 1. In other words, the insertion depth of the rotary tool F1D should be set to such a depth that the upper overlapped portion J1a is disposed on the side face of the protruding portion F6. A plasticized region W1 is formed along a track along which the rotary tool F1D moves.

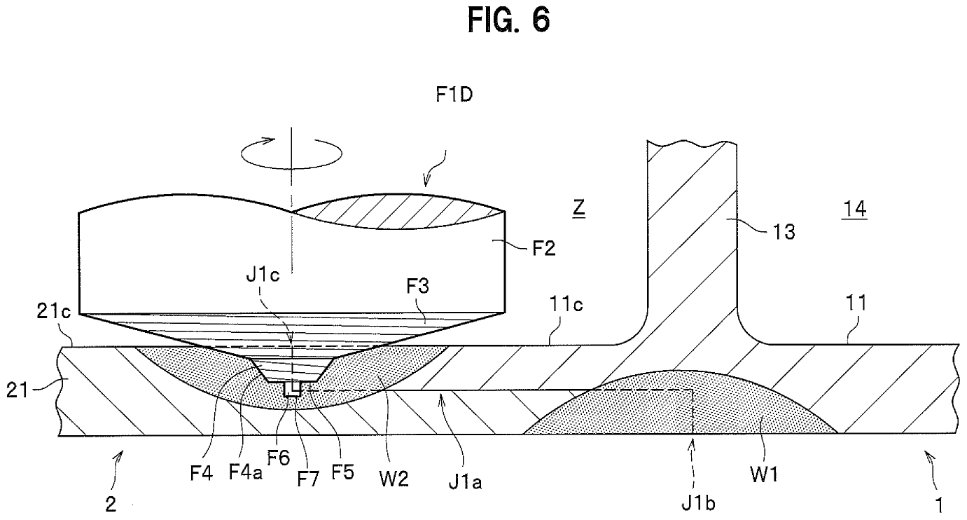

In the upper back side friction stirring process, the rotary tool F1D rotating clockwise is inserted into the upper back side abutted portion J1c as shown in FIG. 6 and moves along the upper back side abutted portion J1c. As seen in FIG. 6, the rotary tool F1D is made to move from the front side toward the backside. An insertion depth by which the rotary tool F1D is inserted is set to such a depth that at least a portion of the base side pin F3 is in contact with both the back face 11c of the upper base plate 11 of the first metal member 1 and the back face 21c of the upper base plate 21 of the second metal member 2. In the present embodiment, the insertion depth is set to such a depth that a portion of the circumferential face of the base side pin F3 that is close to the tip side pin F4 is in contact with the back face 11c of the upper base plate 11 and the back face 21c of the upper base plate 21. Accordingly, friction stir welding is performed with the circumferential face of the base side pin F3 of the rotary tool F1D holding down the back face 11c of the upper base plate 11 and the back face 21c of the upper base plate 21.

In addition, the insertion depth of the rotary tool F1D should be set to so large a depth that a tip face F7 of the protruding portion F6 is inserted deep over the upper overlapped portion J1a with the flat face F5 of the tip side pin F4 is in contact with both the first metal member 1 and the second metal member 2. Therefore, the tip face F7 of the protruding portion F6 is inserted so deep that the tip face F7 is in contact only with the second metal member 2. In other words, the insertion depth of the rotary tool F1D should be set to such a depth that the upper overlapped portion J1a is disposed on the side face of the protruding portion F6. A plasticized region W2 is formed along a track along which the rotary tool F1D moves. The rotary tool F1D may be attached to an arm robot equipped with such a rotation drive means as having a spindle unit on its end portion. Using the robot like this enables easily performing the joining operation in a narrow space like the inner space Z.

In the lower top side friction stirring process, the rotary tool F1D rotating clockwise is inserted into the lower top side abutted portion J2b as shown in FIG. 2 and moves along the lower top side abutted portion J2b. The lower top side friction stirring process is performed in the same manner as the upper top side friction stirring process. Then a detail description on it is skipped.

In the lower back side friction stirring process, the rotary tool F1D rotating clockwise is inserted into the lower back side abutted portion J2c as shown in FIG. 2 and moves along the lower back side abutted portion J2c. The lower back side friction stirring process is performed in the same manner as the upper back side friction stirring process. Then a detail description on it is skipped. The first metal member 1 and the second metal member 2 are joined together through the process above described. In addition to the processes above mentioned, a burr removal process may be performed.

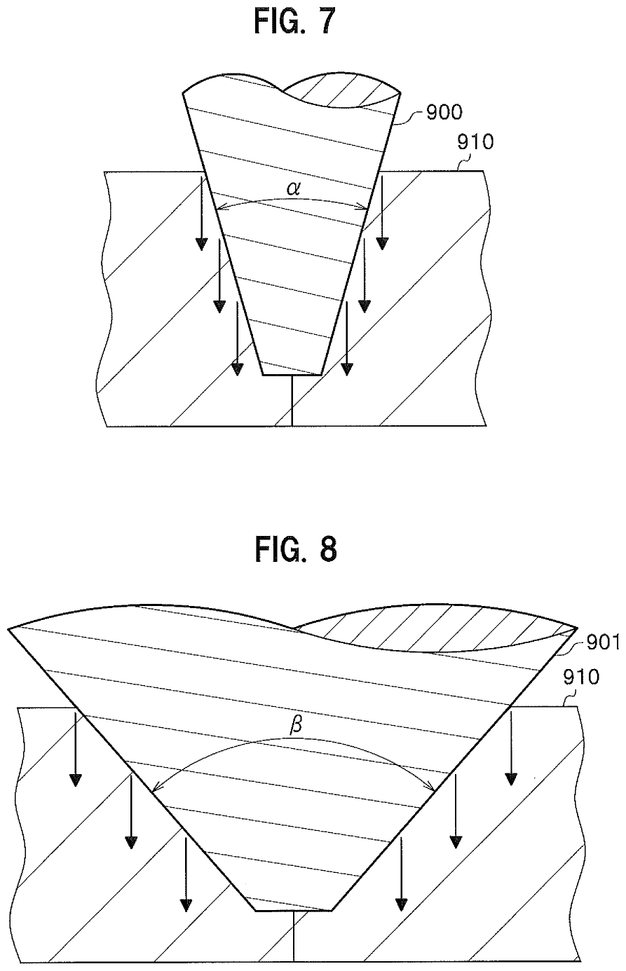

If friction stir welding is performed using a rotary tool 900 of the conventional art as shown in FIG. 7, the top face of the joined metal member 910 is not held down by a shoulder portion of the rotary tool 900. As a result, there are problems with a large concave groove (formed of a top face of the joined metal member and a top face of the plasticized region) being generated and the large surface roughness. There is other problem with a bank portion (a portion of the joined metal member whose surface is elevated from before the joining) is formed on each side of the concave groove. On the other hand, if a rotary tool 901 as shown in FIG. 8 having a taper angle ß larger than a taper angle α of the rotary tool 900 is used, the top face of the metal members to be joined is held down better than the rotary tool 900. As a result, the concave groove becomes smaller and the bank portion is made smaller. However, since more of the plastically flowing material moves downward, a kissing bond is more likely to be formed under the plasticized region.

Looking at the rotary tool F1D of the present embodiment, the rotary tool F1D comprises the base side pin F3 and the tip side pin F4 having the taper angle B smaller than the taper angle A of the base side pin F3. Due to this configuration, the rotary tool F1D is easily inserted into the first metal member 1 and the second metal member 2. Since the taper angle B of the tip side pin F4 is small, the rotary tool F1D can be easily pushed to a deep position in the first metal member 1 and the second metal member 2. In addition, since the taper angle B of the tip side pin F4 is small, the plastically flowing material can be inhibited from moving downward compared with the rotary tool 901. As a result, kissing bonds can be prevented from being generated under the plasticized regions W1, W2. On the hand, since the taper angle A of the base side pin F3 is large, metal members to be joined can be joined reliably even if the thickness of the metal members or the height of the joined portion changes.

Moreover, since the circumferential face of the base side pin F3 holds down the plastically flowing material, the concave groove that is generated on the joined surface can be made smaller and the bank portion that can be made on each side of the concave groove is not made or made lower. In addition, since the step portion 110 in a staircase shape is relatively shallow and has a relatively wide exit, the plastically flowing material can easily move out of the step portion 110 while it is being held down by the step bottom face 110a. Therefore, it is difficult for the plastically flowing material to adhere to the circumferential face of the base side pin F3 though the plastically flowing material is held down by the base side pin F3. As a result, the surface roughness can be made smaller and the joining quality is preferably stabilized.

Moreover, since the tip face F7 of the protruding portion F6 is inserted deep over the upper overlapped portion J1a or the lower overlapped portion J2a in each friction welding process of the present embodiment, portions around each of the upper abutted portion J1a and the lower overlapped portion J2a can be reliably joined. For example, in the upper top side friction stirring process, friction stir welding is performed on both the upper overlapped portion J1a and the upper top side abutted portion J1b, and the joining strength becomes higher.

Furthermore, since the tip side pin F4 of the rotary tool F1D has the flat face F5, the plastically flowing material winding up around the protruding portion F6 is held down by the flat face F5 in the present embodiment. In addition, the tip face F7 of the protruding portion F6 is inserted deep over the upper overlapped portion J1a or the lower overlapped portion J2a in each friction stirring process. Accordingly, oxide films in each of the upper overlapped portion J1a and the lower overlapped portion J2a are reliably broken.

### Second Embodiment

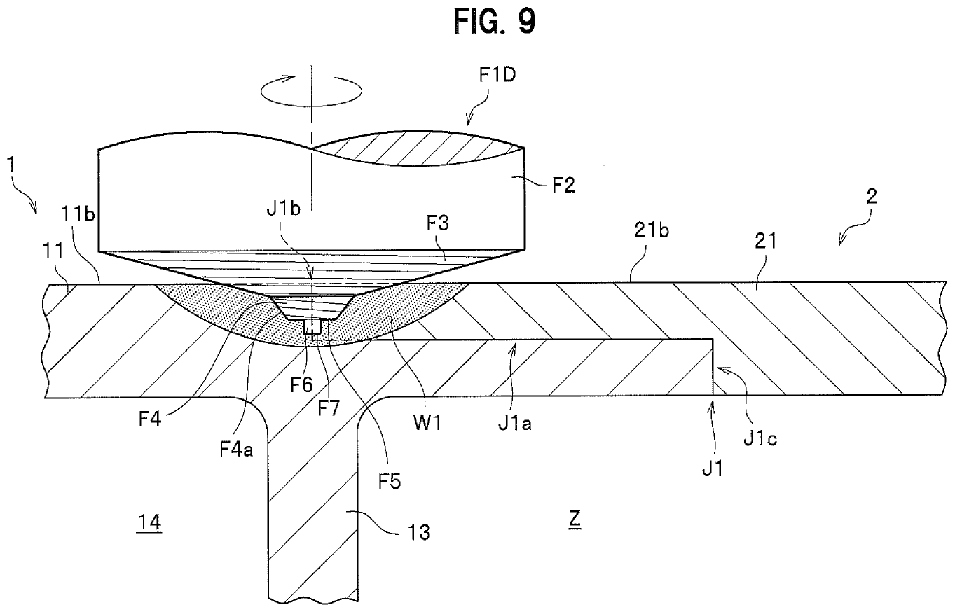

Next, a joining method of a second embodiment of the present invention is described with reference to FIG. 9. A preparation process, an overlapping and abutting process and a friction stirring process are performed in the joining method of the present embodiment. This embodiment differs from the first embodiment in the insertion depth of the rotary tool F1D in the friction stirring process. The following description focusses on the different configuration.

As is shown in FIG. 9, the rotary tool F1D that is rotating clockwise is inserted into the upper top side abutted portion Jlb and made to move along the upper top side abutted portion Jlb in the upper top side friction stirring process. As seen in FIG. 9, the rotary tool F1D is moved from the front side toward the back side. The insertion depth of the rotary tool F1D is set to such a depth that at least a portion of the base side pin F3 is in contact with both the top face 11b of the upper base plate 11 of the first metal member 1 and the top face 21b of the upper base plate 21 of the second metal member 2. In the present embodiment, the insertion depth is set to such a depth that a portion of the circumferential face of the base side pin F3 that is close to the tip side pin F4 is in contact with the top face 11b of the upper base plate 11 and the top face 21b of the upper base plate 21. Accordingly, friction stir welding is performed with the circumferential face of the base side pin F3 of the rotary tool F1D holding down the top face 11b of the upper base plate 11 and the top face 21b of the upper base plate 21.

In addition, the insertion depth of the rotary tool F1D in this embodiment is set to such a depth that each of the flat face F5 of the tip side pin F4 and the tip face F7 of the protruding portion F6 are in contact with both the first metal member 1 and the second metal member 2. Accordingly, the insertion depth of the rotary tool F1D is set to be smaller than a depth to the upper overlapped portion J1a so that the tip face F7 of the protruding portion F6 does not come in contact with the upper overlapped portion J1a. A plasticized region W1 is formed along a track along which the rotary tool F1D moves.

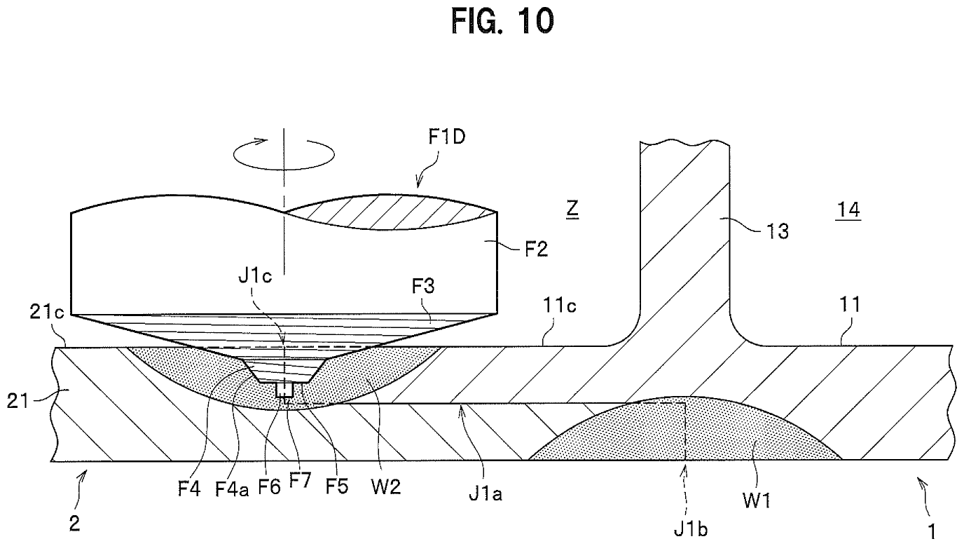

As is shown in FIG. 10, the rotary tool F1D that is rotating clockwise is inserted into the upper back side abutted portion J1c and made to move along the upper back side abutted portion J1c in the upper back side friction stirring process. In FIG. 10, the rotary tool F1D is moved from the front side toward the back side. The insertion depth of the rotary tool F1D is set to such a depth that at least a portion of the base side pin F3 is in contact with both the back face 11c of the upper base plate 11 of the first metal member 1 and the back face 21c of the upper base plate 21 of the second metal member 2. In the present embodiment, the insertion depth is set to such a depth that a portion of the circumferential face of the base side pin F3 that is close to the tip side pin F4 is in contact with the back face 11c of the upper base plate 11 and the back face 21c of the upper base plate 21. Accordingly, friction stir welding is performed with the circumferential face of the base side pin F3 of the rotary tool F1D holding down the back face 11c of the upper base plate 11 and the back face 21c of the upper base plate 21.

In addition, the insertion depth of the rotary tool F1D in this embodiment is set to such a depth that each of the flat face F5 of the tip side pin F4 and the tip face F7 of the protruding portion F6 are in contact with both the first metal member 1 and the second metal member 2. Accordingly, the insertion depth of the rotary tool F1D is set to be smaller than the depth to the upper overlapped portion J1a so that the tip face F7 of the protruding portion F6 does not come in contact with the upper overlapped portion J1a. A plasticized region W2 is formed along a track along which the rotary tool F1D moves.

The lower top side friction stirring process and the lower back side friction stirring process are performed in the same manner as the upper top side friction stirring process and the upper back side friction stirring process. Then the detailed explanations on them are skipped. According to the processes described above, the first metal member 1 and the second metal member 2 are joined together. In addition to the processes above mentioned, a burr removal process may be performed.

According to the joining method as explained above, more or less equivalent effects to those the first embodiment has are obtained. It should be noted that although the tip face F7 of the protruding portion F6 is not inserted so deep as to come across and over the upper overlapped portion J1a or the lower overlapped portion J2a, the plasticized regions W1, W2 are formed to enlarge respectively across and over the upper overlapped portion J1a or the lower overlapped portion J2a in this embodiment. Therefore, the high joining strength is obtained.

### Third Embodiment

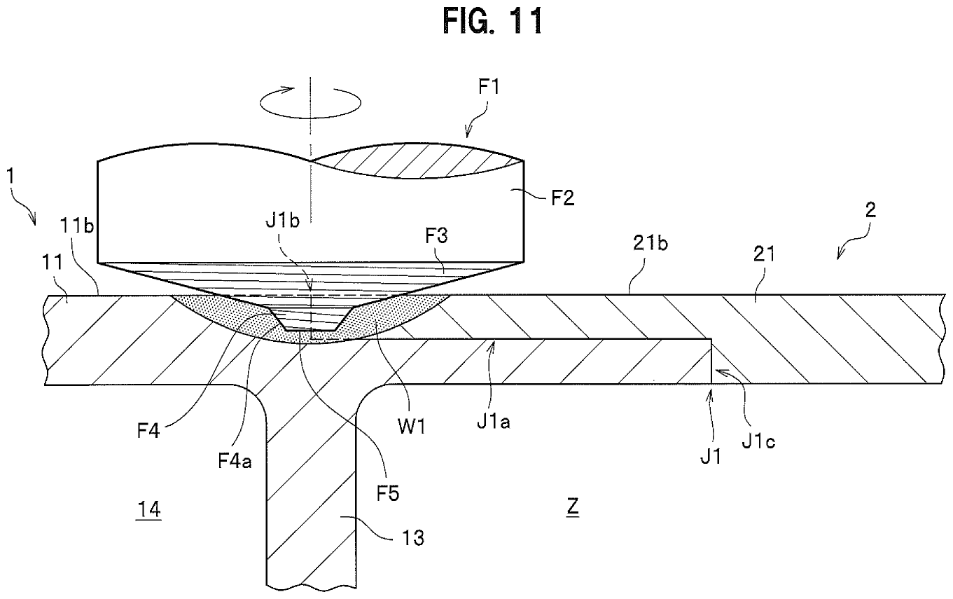

Next, a joining method of a third embodiment of the present invention is described with reference to FIG. 11. A preparation process, an overlapping and abutting process and a friction stirring process are performed in the joining method of this embodiment. The rotary tool used for this joining method is different from that used for the first and second embodiments. The following description focusses on the different configuration.

As shown in FIG. 11, a rotary tool F1 of the present embodiment differs from the rotary tool F1D used for the first and second embodiments in that the rotary tool F1 does not have the protruding portion F6 protruding from and formed on the flat face F5 of the tip side pin F4.

In the upper top side friction stirring process as shown in FIG. 11, the rotary tool F1 that is rotating clockwise is inserted into the upper top side abutted portion Jlb and is made to move along the upper top side abutted portion J1b. As seen in FIG. 11, the rotary tool F1 is made to move from the front side toward the back side. The insertion depth of the rotary tool is set to such a depth that at least a portion of the base side pin F3 is in contact with the top face 11b of the upper base plate 11 and the top face 21b of the upper base plate 21. In the present embodiment, the insertion depth is set to such a depth that a portion of the circumferential face of the base side pin F3 that is close to the tip side pin F4 is in contact with the top face 11b of the upper base plate 11 and the top face 21b of the upper base plate 21. Accordingly, friction stir welding is performed with the circumferential face of the base side pin F3 of the rotary tool F1 holding down the top face 11b of the upper base plate 11 and the top face 21b of the upper base plate 21.

In addition, the insertion depth of the rotary tool F1 in this embodiment is set to such a depth that the flat face F5 of the tip side pin F4 is in contact with both the first metal member 1 and the second metal member 2. Accordingly, the insertion depth of the rotary tool F1 is set to be smaller than the upper overlapped portion J1a so that the flat face F5 of the base side pin F4 does not come in contact with the upper overlapped portion J1a. A plasticized region W1 is formed along a track along which the rotary tool F1 moves.

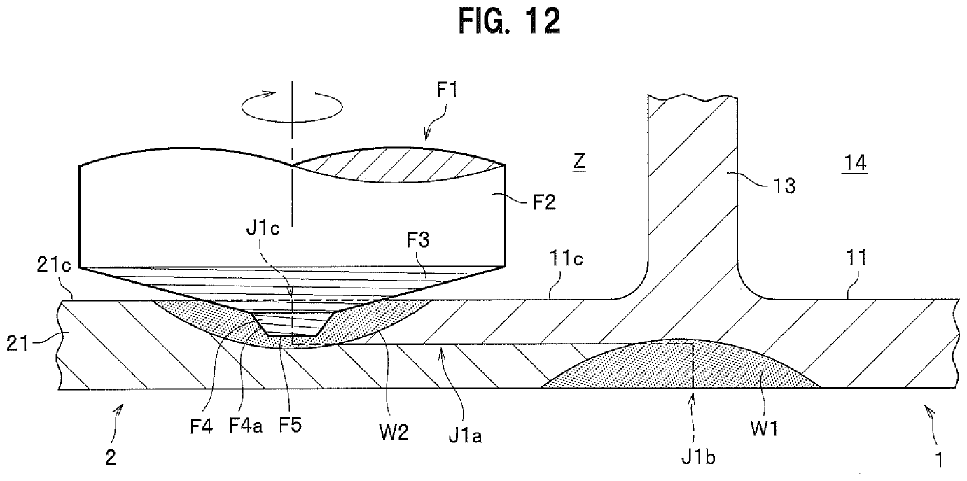

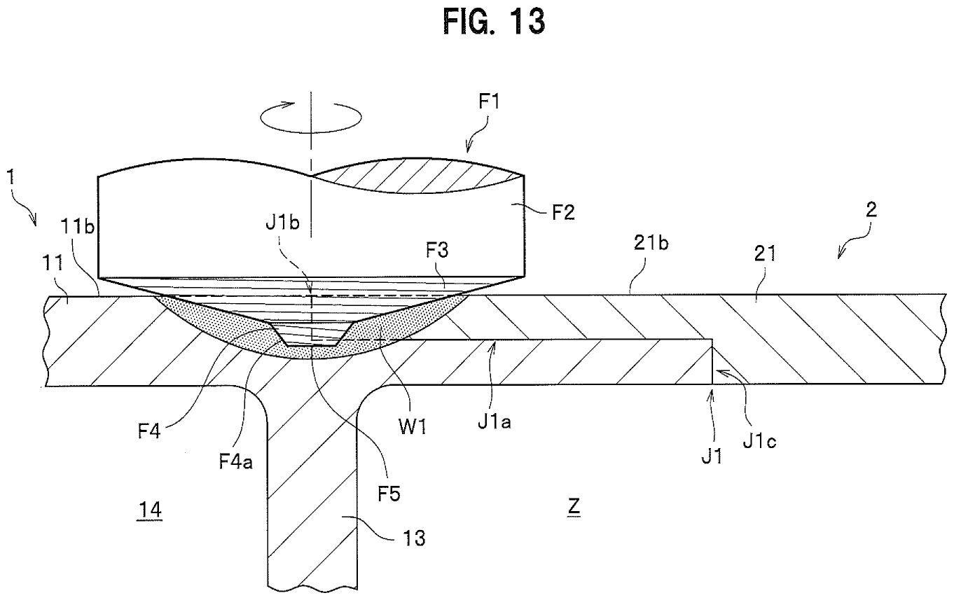

In the upper back side friction stirring process as shown in FIG. 12, the rotary tool F1 that is rotating clockwise is inserted into the upper back side abutted portion J1c and made to move along the upper back side abutted portion J1c. In FIG. 12, the rotary tool F1 is moved from the front side toward the back side. The insertion depth of the rotary tool F1 is set to such a depth that at least a portion of the base side pin F3 is in contact with both the back face 11c of the upper base plate 11 of the first metal member 1 and the back face 21c of the upper base plate 21 of the second metal member 2. In the present embodiment, the insertion depth is set to such a depth that a portion of the circumferential face of the base side pin F3 that is close to the tip side pin F4 is in contact with the back face 11c of the upper base plate 11 and the back face 21c of the upper base plate 21. Accordingly, friction stir welding is performed with the circumferential face of the base side pin F3 of the rotary tool F1 holding down the back face 11c of the upper base plate 11 and the back face 21c of the upper base plate 21.

In addition, the insertion depth of the rotary tool F1 in this embodiment is set to such a depth that the flat face F5 of the tip side pin F4 is in contact with both the first metal member 1 and the second metal member 2. Accordingly, the insertion depth of the rotary tool F1 is set to be smaller than the depth to the upper overlapped portion J1a so that the flat face F5 of the base side pin F4 does not come in contact with the upper overlapped portion J1a. A plasticized region W2 is formed along a track along which the rotary tool F1 moves.

The lower top side friction stirring process and the lower back side friction stirring process are performed in the same manner as the upper top side friction stirring process and the upper back side friction stirring process. Then the detailed explanations on them are skipped. According to the processes described above, the first metal member 1 and the second metal member 2 are joined together. In addition to the processes above mentioned, a burr removal process may be performed.

According to the joining method as explained above, more or less equivalent effects to those the first embodiment has are obtained. It should be noted that although the flat face F5 of the base side pin F5 is not inserted so deep as to come across and over the upper overlapped portion J1a or the lower overlapped portion J2a, the plasticized regions W1, W2 are formed to enlarge respectively across and over the upper overlapped portion J1a or the lower overlapped portion J2a in this embodiment. Therefore, the high joining strength is obtained.

### Fourth Embodiment

Next, a joining method of a fourth embodiment of the present invention is described with reference to FIG. 13. A preparation process, an overlapping and abutting process and a friction stirring process are performed in the joining method of this embodiment. The insertion depth of the rotary tool used for this joining method is different from that used for the third embodiment. The following description focusses on the different configuration.

In the upper top side friction stirring process as shown in FIG. 13, the rotary tool F1 that is rotating clockwise is inserted into the upper top side abutted portion Jlb and is made to move along the upper top side abutted portion J1b. In FIG. 13, the rotary tool F1 is made to move from the front side toward the back side. The insertion depth of the rotary tool is set to such a depth that at least a portion of the base side pin F3 is in contact with the top face 11b of the upper base plate 11 and the top face 21b of the upper base plate 21. In this embodiment, the insertion depth is set to such a depth that a portion of the circumferential face of the base side pin F3 that is positioned around at half the height of the base side pin F3 in an axial direction of the base side pin F3 is in contact with the top face 11b of the upper base plate 11 of the first metal member 1 and the top face 21b of the upper base plate 21 of the second metal member 2. Accordingly, friction stir welding is performed with the circumferential face of the base side pin F3 of the rotary tool F1 holding down the top face 11b of the upper base plate 11 and the top face 21b of the upper base plate 21.

In addition, the insertion depth of the rotary tool F1 in this embodiment is set to such a depth that the flat face F5 of the tip side pin F4 is inserted deep over the upper top side overlapped portion J1a with the base side pin F3 and the tip side pin F4 of the rotary tool F1 being in contact with both the upper base plate 11 of the first metal member 1 and the upper base plate 21 of the second metal member 2. Accordingly, the flat face F5 of the tip side pin F4 is inserted to be in contact only with the first metal member 1. In other words, the insertion depth of the rotary tool F1 is set to such a depth that the upper top side overlapped portion J1a is on the side of the tip side pin F4. A plasticized region W1 is formed along a track along which the rotary tool F1 moves.

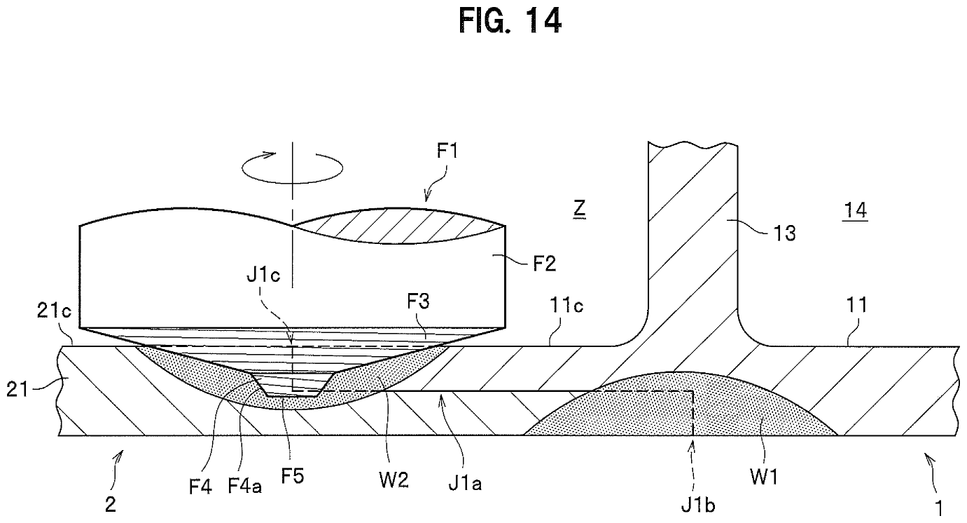

In the upper back side friction stirring process as shown in FIG. 14, the rotary tool F1 that is rotating clockwise is inserted into the upper top side abutted portion J1c and is made to move along the upper top side abutted portion J1c. As seen from FIG. 14, the rotary tool F1 is made to move from the front side toward the back side. The insertion depth of the rotary tool F1 is set to such a depth that at least a portion of the base side pin F3 is in contact with the back face 11c of the upper base plate 11 of the first metal member 1 and the back face 21c of the upper base plate 21 of the second metal member 2. In the present embodiment, the insertion depth is set to such a depth that a portion of the circumferential face of the base side pin F3 that is positioned around at half the height of the base side pin F3 in the axial direction of the base side pin 3 is in contact with the back face 11c of the upper base plate 11 and the back face 21c of the upper base plate 21. Accordingly, friction stir welding is performed with the circumferential face of the base side pin F3 of the rotary tool F1 holding down the back face 11c of the upper base plate 11 and the back face 21c of the upper base plate 21.

In addition, the insertion depth of the rotary tool F1 in this embodiment is set to such a depth that the flat face F5 of the tip side pin F4 is inserted deep over the upper top side overlapped portion J1a with the base side pin F3 and the tip side pin F4 of the rotary tool F1 being in contact with both the upper base plate 11 of the first metal member 1 and the upper base plate 21 of the second metal member 2. Accordingly, the flat face F5 of the tip side pin F4 is inserted to be in contact only with the second metal member 2. In other words, the insertion depth of the rotary tool F1 is set to such a depth that the upper top side overlapped portion J1a is on the side of the tip side pin F4. A plasticized region W2 is formed along a track along which the rotary tool F1 moves.

The lower top side friction stirring process and the lower back side friction stirring process are performed in the same manner as the upper top side friction stirring process and the upper back side friction stirring process. Then the detailed explanations on them are skipped. According to the processes described above, the first metal member 1 and the second metal member 2 are joined together. In addition to the processes above mentioned, a burr removal process may be performed.

According to the joining method as explained above, more or less equivalent effects to those the first embodiment has are obtained. Since the flat face F5 of the tip side pin F4 is inserted deep over the upper overlapped portion J1a or the lower overlapped portion J2a in each friction stirring process in the present embodiment, portions around each of the upper overlapped portion J1a and the lower overlapped portion J2a are reliably joined. For example, friction stir welding is performed on both the upper overlapped portion J1a and the upper top side abutted portion Jlb in the upper top side friction welding process and the joining strength becomes larger accordingly.

### Fifth Embodiment

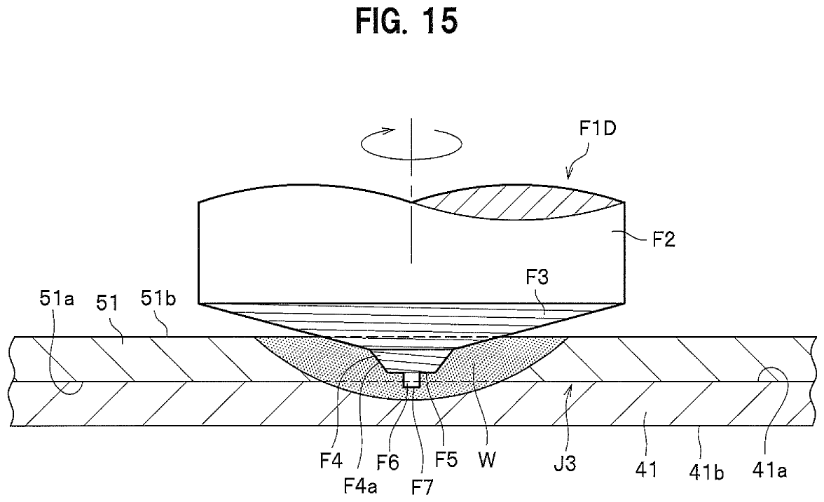

Next, a joining method of a fifth embodiment of the present invention is described with reference to FIG. 15. The joining method of the fifth embodiment differs from the first embodiment in that the first metal member 1 and the second metal member 2 which are in a shape of a plate are used for the joining method of the fifth embodiment. The following description on the fifth embodiment focusses on the different configuration. A preparation process, a stacking process and a friction stirring process are performed in the joining method of this embodiment.

The preparation process is intended to prepare the first metal member 1 and the second metal member 2. Each of the first metal member 1 and the second metal member 2 constitutes a part of a double skin panel and is a metal member that is in a shape of a plate and capable of being friction-stir-welded.

The stacking process is intended to stack the first metal member 41 and the second metal member 51 on each other. In this process, a top face 41a of the first metal member 41 and a back face 51a of the second metal member 51 come in contact with each other and an overlapped portion J3 is formed.

In the friction stirring process of this embodiment, friction-stir-welding is performed on the overlapped portion J3 using the rotary tool F1D. During the friction stirring process, the rotary tool F1D that is rotating is inserted through a top face 51b of the second metal member 51 and is made to move on the top face 51b of the second metal member 51. The insertion depth of the rotary tool F1D is set to such a depth that at least a portion of the base side pin F3 is in contact with the top face 51b of the second metal member 51. That is, friction-stir-welding is under way with the circumferential face of the base side pin F3 of the rotary tool F1D holding down the top face 51b of the second metal member 51. Moreover, the insertion depth of the rotary tool F1D is set to such a depth that the tip face F7 of the protruding portion F6 is kept under the overlapped portion J3 while the flat face F5 of the tip side pin F4 is kept over the overlapped portion J3. In other words, the insertion depth of the rotary tool F1D is set to such a depth that the overlapped portion J3 is on the side of the protruding portion F6.

The joining method of the fifth embodiment as described above uses the rotary tool F1D comprising the base side pin F3 having a tapered shape with a taper angle A and the tip side pin F4 having a tapered shape with a taper angle B that is smaller than the taper angle A. The rotary tool F1D having this configuration can be easily inserted into the second metal member 51. In addition, since the taper angle B of the tip side pin F4 is relatively small, the rotary tool F1D can be pushed easily to a deep position in the second metal member 51. Moreover, since the taper angle B of the tip side pin F4 is relatively small, the plastically flowing material is better inhibited from moving downward compared with the rotary tool 901. As a result, formation of a kissing bond under the plasticized region is prevented. On the other hand, since the base side pin F3 has the taper angle A that is relatively large, members to be joined can be reliably joined together even if the thickness of the members or the height position of joining varies.

Moreover, since the circumferential face of the base side pin F3 holds down the plastically flowing material, the concave groove that is formed on the joined surface can be made smaller and the bank portion that can be generated on each side of the concave groove is not made or is made lower. In addition, since the step portion 110 in a staircase shape is relatively shallow and has a relatively wide exit, the plastically flowing material can easily move out of the step portion 110 while it is being held down by the step bottom face 110a. Therefore, it is difficult for the plastically flowing material to adhere to the circumferential face of the of the base side pin F3 though the plastically flowing material is held down by the base side pin F3. As a result, the surface roughness can be made smaller and the joining quality is preferably stabilized.

Furthermore, since the tip side pin F4 of the rotary tool F1D has the flat face F5, the plastically flowing material winding up around the protruding portion F6 is held down by the flat face F5 in the present embodiment. In addition, the tip face F7 of the protruding portion F6 is inserted deep over the overlapped portion J3. Accordingly, oxide films in each of the upper overlapped portion J1a and the lower overlapped portion J2a are reliably broken.

In the present embodiment, the insertion depth may be set to such a depth that the tip face F7 of the protruding portion F6 comes above the overlapped portion J3. That is, the insertion depth of the rotary tool F1D may be set to such a depth that the tip side pin F4 is in contact only with the second metal member 51. In this case, at least a portion of the base side pin F3 has to be in contact with the top face 51b of the second metal member 51. In this case, the overlapped portion J3 is plasticized by friction heat between the rotary tool F1D and the second metal member 51.

In the friction stirring process of this embodiment, the flat face F5 of the tip side pin F4 may be inserted deep across and over the overlapped portion J3.

In addition, friction-stir welding may be further performed on the overlapped portion J3 with the rotary tool F1D inserted from the back face 41b of the first metal member 41. When this friction stir welding is performed, the front side plasticized region and the back side plasticized region may partially overlap with each other.

### Sixth Embodiment

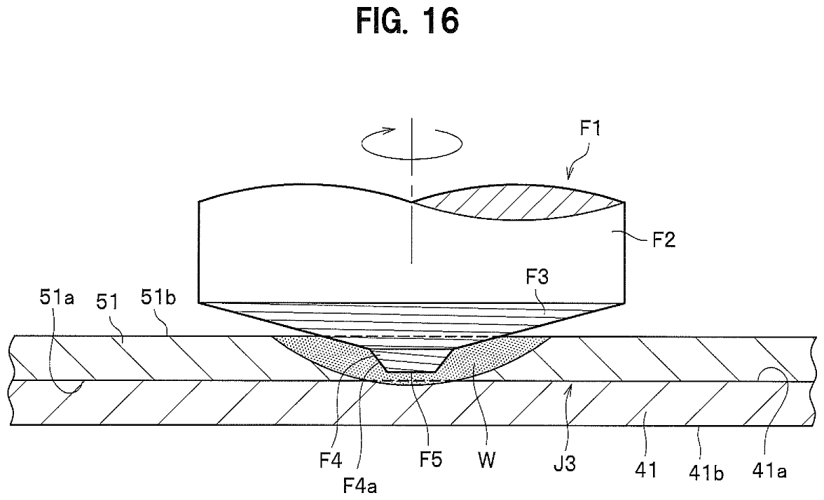

Next, a sixth embodiment of the present invention is described with reference to FIG. 16. A preparation process, a stacking process and a friction stirring process are performed in the joining method of this embodiment. The joining method of this embodiment differs from the fifth embodiment in the rotary tool. The following description focusses on the different configuration.

As is shown in FIG. 16, the rotary tool F1 used for this embodiment differs from the rotary tool F1D used for the fifth embodiment in that the rotary tool F1 does not have a protruding portion F6 protruding from the flat face F5 of the tip side pin F4.

In the friction stirring process of this embodiment, the rotary tool F1 that is rotating is inserted into the second metal member 51 from the top face 51b of the second metal member 51 and is made to move along the top face 61b of the second metal member 51. The insertion depth of the rotary tool F1 is set to such a depth that at least a portion of the base side pin F3 is in contact with the top face 51b of the second metal member 51. That is, friction stir welding is under way with the circumferential face of the base side pin F3 of the rotary tool F1 holding down the top face 51b of the second metal member 51. Moreover, the insertion depth of the rotary tool F1 is set to such a depth that the flat face F5 of the tip side pin F4 is above the overlapped portion J3. That is, the insertion depth of the rotary tool F1 is set to such a depth that the tip side pin F4 is in contact only with the second metal member 51. In other words, the insertion depth of the rotary tool F1 is smaller than the depth of the overlapped portion J3 so that the flat face F5 of the tip side pin F4 does not come in contact with the overlapped portion J3. In this case, the overlapped portion is plasticized by the friction heat between the rotary tool F1 and the second metal member 51.

The joining method of the sixth embodiment as described above has more or less the same effect as the fifth embodiment.

In this embodiment, the insertion depth of the rotary tool F1 may be set to such a depth that the flat face F5 of the tip side pin F4 comes below the overlapped portion J3. That is, the insertion depth of the rotary tool F1 is set to such a depth that the tip side pin F4 is in contact with both the second metal member 51 and the first metal member 41. In other words, the insertion depth of the rotary tool F1 may be larger than the depth of the overlapped portion J3 so that the overlapped portion J3 is on the side of the tip side pin F4. In this case, at least a portion of the base side pin F3 has to be in contact with the top face 51b of the second metal member 51.

In addition, friction-stir welding may be further performed on the overlapped portion J3 with the rotary tool F1D inserted from the back face 41b of the first metal member 41. When this friction stir welding is performed, the front side plasticized region and the back side plasticized region may partially overlap with each other.

### Modified Example

Next, modified examples of the rotary tools F1, F1D used for the embodiments above described are described.

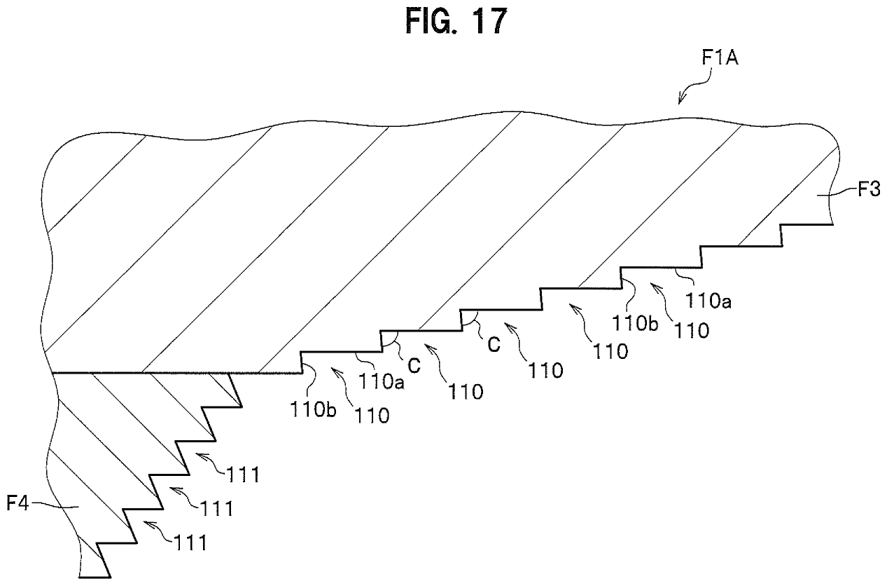

FIG. 17 is a cross-sectional view of a rotary tool of a first modified example of the rotary tool used for the embodiments above described. A rotary tool F1A of a first modified example as shown in FIG. 17 has the step angle C equal to 85° between the step bottom face 110a and the step side face 110b of the step portion 110. The step bottom face 110a is in parallel with the horizontal face. Like this example, the step angle C may be such an acute angle that the plastically flowing material moves out of the step portion 110 without being stuck at and adhering to the step portion 110, with the step bottom face 110a in parallel with the horizontal face.

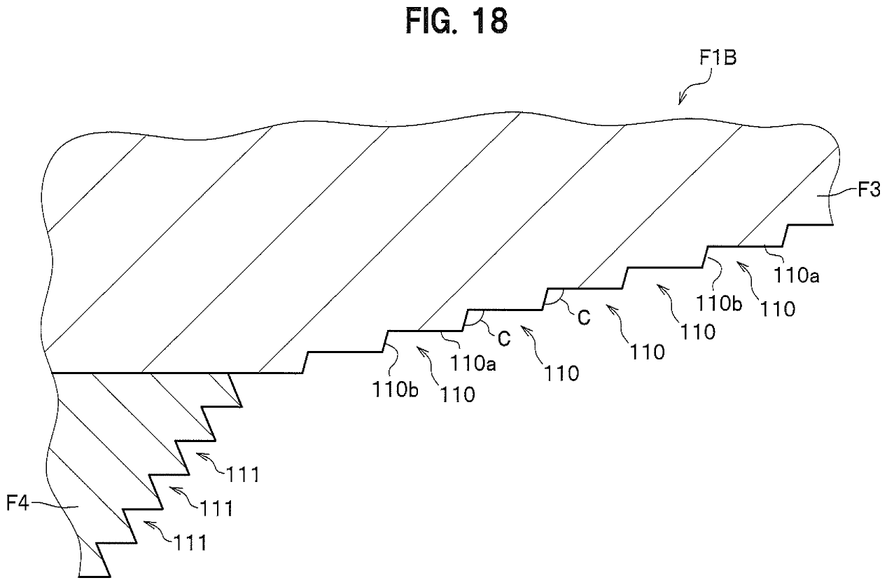

FIG. 18 is a cross-sectional view of a rotary tool of a second modified example of the rotary tool used for the embodiments above described. A rotary tool F1B of the second modified example has the step portion 110 with a step angle C equal to 115°. The step bottom face 110a is in parallel with the horizontal face. Like this example, the step angle C may be such an obtuse angle that the step portion 110 functions as a step, with the step bottom face 110a in parallel with the horizontal face.

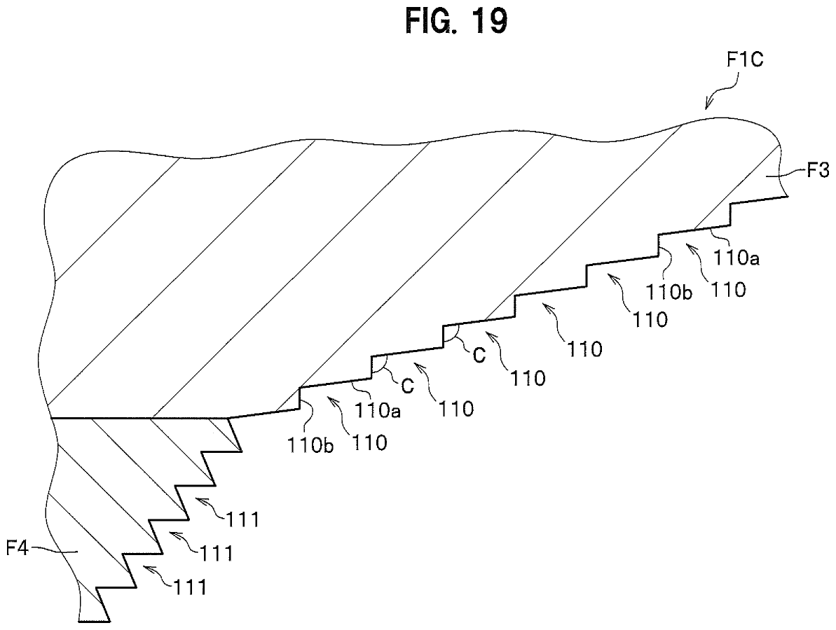

FIG. 19 is a cross-sectional view of a rotary tool of a third modified example of the rotary tool used for the embodiments above described. As shown in FIG. 19, the step bottom face 110a slopes upward at an angle of 10° in the direction from the rotation axis to the circumference. The step side face 110b is in parallel with the vertical face. Like this example, the step bottom face 110a may have such an upward slope relative to the horizontal face in the direction from the rotation axis of the tool to the circumference that the plastically flowing material can be held down while friction stir welding is under way. If any of the rotation tools of the first to third examples is used, the same effect as is obtained by the embodiments above described is obtained.

The embodiments of the present invention as described above may be appropriately modified with the scope of the present invention.

### DESCRIPTION OF SIGNS

1, 41 first metal member
2, 51 second metal member
F1, F1A, F1B, F1C, F1D rotary tool
F2 base axis portion
F3 base side pin
F4 tip side pin
F5 flat face
F6 protruding portion
F7 tip face
110 step portion
110a step bottom face
110b step side face
111 spiral groove
A taper angle (of base side pin)
B taper angle
C step angle
D spiral groove angle
X1 length (of base side pin)
X2 length
Y1 height (of step side face)
Y2 height
J1 abutted portion
J1a upper overlapped portion
Jlb upper top side abutted portion
J1c upper back side abutted portion
J2 abutted portion
J2a lower overlapped portion
J2b lower top side abutted portion
J2c lower back side abutted portion
J3 overlapped portion
W1, W2, W3 plasticized region

1. A joining method for joining a first metal member and a second metal member together using a rotary tool for friction stirring comprising a base side pin and a tip side pin, comprising;
a preparation process of forming a first step bottom face and a first step side face on a top face of an end portion of the first metal member and forming a second step bottom face and a second step side face on a back face of an end portion of the second metal member;
an overlapping and abutting process of forming a overlapped portion of the first step bottom face and the second step bottom face which are overlapped with each other and forming a top side abutted portion of the first step side face and an end face of the second metal member which abut each other and a back side abutted portion of the second step side face and an end face of the first metal member which abut each other; and
a friction stirring process of inserting the tip side pin that is rotating into the top side abutted portion and moving the rotary tool along the top side abutted portion with each of the base side pin and the tip side pin being in contact with both the first metal member and the second metal member to join each of the top side abutted portion and the overlapped portion,
wherein the base side pin has a first taper angle while the tip side pin has a second taper angle that is smaller than the first taper angle, a circumferential face of the base side pin has a step portion in a staircase shape formed thereon and the tip side pin has a flat face that is vertical to a rotation axis of the rotary tool and a protruding portion protruding from the flat face, and
wherein each of the top side abutted portion and the overlapped portion is being joined with the flat face being in contact with both the first metal member and the second metal member and with a tip face of the protruding portion being inserted deep over the overlapped portion in the friction stirring process.

2. A joining method for joining a first metal member and a second metal member together using a rotary tool for friction stirring comprising a base side pin and a tip side pin, comprising;
a preparation process of forming a first step bottom face and a first step side face on a top face of an end portion of the first metal member and forming a second step bottom face and a second step side face on a back face of an end portion of the second metal member;
an overlapping and abutting process of forming an overlapped portion of the first step bottom face and the second step bottom face which are overlapped with each other and forming a top side abutted portion of the first step side face and an end face of the second metal member which abut each other and a back side abutted portion of the second step side face and an end face of the first metal member which abut each other; and
a friction stirring process of inserting the tip side pin that is rotating into the back side abutted portion and moving the rotary tool along the back side abutted portion with each of the base side pin and the tip side pin being in contact with both the first metal member and the second metal member to join each of the back side abutted portion and the overlapped portion,
wherein the base side pin has a first taper angle while the tip side pin has a second taper angle that is smaller than the first taper angle, a circumferential face of the base side pin has a step portion in a staircase shape formed thereon and the tip side pin has a flat face that is vertical to a rotation axis of the rotary tool and a protruding portion protruding from the flat face, and
wherein each of the back side abutted portion and the overlapped portion are being joined with the flat face being in contact with both the first metal member and the second metal member and with a tip face of the protruding portion being inserted deep over the overlapped portion in the friction stirring process.

3. A joining method for joining a first metal member and a second metal member together using a rotary tool for friction stirring comprising a base side pin and a tip side pin, the joining method comprising;
a preparation process of forming a first step bottom face and a first step side face on a top face of an end portion of the first metal member and forming a second step bottom face and a second step side face on a back face of an end portion of the second metal member;
an overlapping and abutting process of forming an overlapped portion of the first step bottom face and the second step bottom face which are overlapped with each other and forming a top side abutted portion of the first step side face and an end face of the second metal member which abut each other and a back side abutted portion of the second step side face and an end face of the first metal member which abut each other; and
a friction stirring process of inserting the tip side pin that is rotating into the top side abutted portion and moving the rotary tool along the top side abutted portion with each of the base side pin and the tip side pin being in contact with both the first metal member and the second metal member to join the joined top side abutted portion,
wherein the base side pin has a first taper angle while the tip side pin has a second taper angle that is smaller than the first taper angle, a circumferential face of the base side pin has a step portion in a staircase shape formed thereon and the tip side pin has a flat face that is vertical to a rotation axis of the rotary tool and a protruding portion protruding from the flat face, and
wherein the top side abutted portion is being joined with each of the flat face and a tip face of the protruding portion being in contact with both the first metal member and the second metal member in the friction stirring process.

4. A joining method for joining a first metal member and a second metal member together using a rotary tool for friction stirring comprising a base side pin and a tip side pin, comprising;
a preparation process of forming a first step bottom face and a first step side face on a top face of an end portion of the first metal member and forming a second step bottom face and a second step side face on a back face of an end portion of the second metal member;
an overlapping and abutting process of forming an overlapped portion of the first step bottom face and the second step bottom face which are overlapped with each other and forming a top side abutted portion of the first step side face and an end face of the second metal member which abut each other and a back side abutted portion of the second step side face and an end face of the first metal member which abut each other; and
a friction stirring process of inserting the tip side pin that is rotating into the back side abutted portion and moving the rotary tool along the back side abutted portion with each of the base side pin and the tip side pin being in contact with both the first metal member and the second metal member to join the back side abutted portion,
wherein the base side pin has a first taper angle while the tip side pin has a second taper angle that is smaller than the first taper angle, a circumferential face of the base side pin has a step portion in a staircase shape formed thereon and the tip side pin has a flat face that is vertical to a rotation axis of the rotary tool and a protruding portion protruding from the flat face, and
wherein the back side abutted portion is being joined with each of the flat face and a tip face of the protruding portion being in contact with both the first metal member and the second metal member in the friction stirring process.

5. A joining method for joining a first metal member and a second metal member together using a rotary tool for friction stirring comprising a base side pin and a tip side pin, comprising;
a preparation process of forming a first step bottom face and a first step side face on a top face of an end portion of the first metal member and forming a second step bottom face and a second step side face on a back face of an end portion of the second metal member;
an overlapping and abutting process of forming an overlapped portion of the first step bottom face and the second step bottom face which are overlapped with each other and forming a top side abutted portion of the first step side face and an end face of the second metal member which abut each other and a back side abutted portion of the second step side face and an end face of the first metal member which abut each other; and
a friction stirring process of inserting the tip side pin that is rotating into the top side abutted portion and moving the rotary tool along the top side abutted portion with each of the base side pin and the tip side pin being in contact with both the first metal member and the second metal member to join the top side abutted portion,
wherein the base side pin has a first taper angle while the tip side pin has a second taper angle that is smaller than the first taper angle and a circumferential face of the base side pin has a step portion in a staircase shape formed thereon.

6. The joining method as described in claim 5, wherein a flat face formed on a tip of the tip side pin is inserted deep over the overlapped portion in the friction stirring process.

7. A joining method for joining a first metal member and a second metal member together using a rotary tool for friction stirring comprising a base side pin and a tip side pin, comprising;
a preparation process of forming a first step bottom face and a first step side face on a top face of an end portion of the first metal member and forming a second step bottom face and a second step side face on a back face of an end portion of the second metal member;
an overlapping and abutting process of forming an overlapped portion of the first step bottom face and the second step bottom face which are overlapped with each other and forming a top side abutted portion of the first step side face and an end face of the second metal member which abut each other and a back side abutted portion of the second step side face and an end face of the first metal member which abut each other, and
a friction stirring process of inserting the tip side pin that is rotating into the back side abutted portion and moving the rotary tool along the back side abutted portion with each of the base side pin and the tip side pin being in contact with both the first metal member and the second metal member to join the back side abutted portion,
wherein the base side pin has a first taper angle while the tip side pin has a second taper angle that is smaller than the first taper angle and a circumferential face of the base side pin has a step portion in a staircase shape formed thereon.

8. The joining method as described in claim 7, wherein a flat face formed on a tip of the tip side pin is inserted deep over the overlapped portion in the friction stirring process.

9. A joining method for joining a first metal member and a second metal member together using a rotary tool for friction stirring comprising a base side pin and a tip side pin, comprising,
a stacking process of forming an overlapped portion of a top face of the first metal member and a back face of the second metal member which are overlapped with each other; and
a friction stirring process of inserting the tip side pin that is rotating into the overlapped portion from a surface of the second metal member so that only the tip side pin is in contact with the first metal member and moving the rotary tool along the overlapped portion with the base side pin and the tip side pin both being in contact with the second metal member to join the overlapped portion,
wherein the base side pin has a first taper angle while the tip side pin has a second taper angle that is smaller than the first taper angle, a circumferential face of the base side pin has a step portion in a staircase shape formed thereon and the tip side pin has a flat face that is vertical to a rotation axis of the rotary tool and a protruding portion protruding from the flat face, and
wherein the overlapped portion is being joined with the flat face being in contact with the second metal member and a tip face of the protruding portion being in contact with the first metal member in the friction stirring process.

10. A joining method for joining a first metal member and a second metal member together using a rotary tool for friction stirring comprising a base side pin and a tip side pin, comprising,
a stacking process of forming an overlapped portion of a top face of the first metal member and a back face of the second metal member which are overlapped with each other; and
a friction stirring process of inserting the tip side pin that is rotating into the overlapped portion from a surface of the second metal member and moving the rotary tool along the overlapped portion with the base side pin and the tip side pin both being in contact with the second metal member to join the overlapped portion,
wherein the base side pin has a first taper angle while the tip side pin has a second taper angle that is smaller than the first taper angle and a circumferential face of the base side pin has a step portion in a staircase shape formed thereon, and
wherein the overlapped portion is being joined with the tip side pin being in contact either with only the second metal member or with both the second metal member and the first metal member.
